(19) United States
(12) Patent Application Publication
(10) Pub. No.: US 2013/0257201 A1
(43) Pub. Date: Oct. 3, 2013

(54) ELECTRICAL MACHINE

(71) Applicant: Baumueller Nuernberg GMBH, Nuernberg (DE)

(72) Inventors: PETER LEMKE, SCHWABACH (DE); FRANK GUTJAHR, ETZELWANG (DE)

(73) Assignee: BAUMUELLER NUERNBERG GMBH, Nuernberg (DE)

(21) Appl. No.: 13/903,113

(22) Filed: May 28, 2013

Related U.S. Application Data
(63) Continuation of application No. PCT/EP2011/005509, filed on Nov. 2, 2011.

(30) Foreign Application Priority Data
Nov. 25, 2010 (DE) 20 2010 015 860.5
Apr. 13, 2011 (DE) 20 2011 005 228.1
May 18, 2011 (DE) 10 2011 101 932.8

(51) Int. Cl. H02K 5/22

(52) U.S. Cl. CPC H02K 5/225
USPC 310/71

(57) ABSTRACT

An electric machine with a machine housing for accommodating a stator and a rotor with stator and/or rotor windings, which are connected to connecting lines for producing an electrical contact connection. An isolating plate, which covers a line channel for accommodating the connecting lines, has a number of insulating bushes, into which connecting pins are inserted which can be brought into contact with the connecting lines. In this case, the connecting pins with respect to the insulating bushes and preferably the insulating bushes are inserted into the isolating plate in position-coded or angle-coded fashion with respect to the isolating plate.

### CROSS-REFERENCE TO RELATED APPLICATION

This application is a continuation, under 35 U.S.C. §120, of copending international application No. PCT/EP2011/005509, filed Nov. 2, 2011, which designated the United States; this application also claims the priority, under 35 U.S.C. §119, of German patent application No. DE 20 2010 015 860.5, filed Nov. 25, 2010, German patent application No. DE 20 2011 005 228.1, filed Apr. 13, 2011 and German patent application No. DE 10 2011 101 932.8, filed May 18, 2011; the prior applications are herewith incorporated by reference in their entireties.

### BACKGROUND OF THE INVENTION

### Field of the Invention

The invention relates to an electrical machine with a machine housing for receiving a stator and a rotor with stator and/or rotor windings, which are connected to connecting lines for making electrical connection contact. An electrical machine is understood here as meaning in particular a fluid-cooled motor or generator, preferably with an integrated converter, as a drive operating on the principle of a motor or a generator for a unit or auxiliary unit of a commercial vehicle.

In particular depending on the area of use and on the power output, such an electrical machine is often cooled with a fluid on the stator side. The cooling medium, preferably oil, is usually fed by a pump, which is actuated by the electrical machine itself or by a separate drive. The electrical machine is generally operated by power electronics (converters, in particular frequency converters, DC/AC or AC/DC transformers or the like). The electronics suitably have a bridge circuit containing semiconductor switches, the number of which, like the number of arms of the bridge, is dependent on the number of phases of the electrical machine, three-phase or multi-phase motors and generators being customary.

Depending on whether the electrical machine is operated as a motor or as a generator, the electrical power is either fed to the machine for the desired rotational speed and the intended torque, or the electrical power is removed from the electrical machine and fed to downstream units, for example of a commercial vehicle. In the operating mode as a generator, the multi-phase alternating current produced on a generator basis is converted by the electronics (converters) into a direct current, which is then fed to the respective unit or consumer, for example by way of an intermediate circuit.

In particular on account of frequently encountered confined space conditions and small overall volume, a compact type of construction with which the power control or electronics is integrated as far as possible in the electrical machine is desirable.

In the case of a fluid-cooled electrical machine, for example with a directly oil-cooled stator winding, a pressure-tight lead-through of the electrical machine connections is required in order to be able to connect the machine electrically to a converter or to the power control. Electrical signals, for example from temperature sensors, also often have to be led out from the region of the machine that is exposed to oil.

### SUMMARY OF THE INVENTION

The invention is based on the object of providing an electrical machine that is as compact as possible. In particular, suitable line routings and reliable, easy-installation handling when assembling the machine connections are intended to be made possible.

For this purpose, in the case of an electrical machine, in particular a stator-side cooled generator, the machine housing that serves for receiving a stator and a rotor with stator and/or rotor windings is provided with a line channel for receiving connecting lines connected to the windings. The line channel, which preferably runs in the longitudinal direction of the machine on the outer side of the machine housing, is covered by a separating plate with a number of insulating bushes, inserted in which in a position-coded manner are connection pins that can be brought into electrical contact with the connecting lines. The separating plate is intended for the particularly pressure-tight covering of the line channel.

The connecting lines are virtually the winding ends of the machine windings or coils, the free ends of which are led to the connection pins forming the machine or phase connections and are screw-contacted there, preferably by cable lugs. The connecting lines are suitably led from the machine-internal windings by way of a through-opening in the housing wall and bent around into the line channel. Since the connecting lines to be laid in the line channel, which expediently runs in the longitudinal direction of the housing, are sufficiently long for such bending-around in the region of the through-opening into the line channel, with at the same time a virtually minimized space requirement, a correspondingly sufficient spring-deflecting or bending distance is produced in order to make contact with the machine connections as intended during assembly, without having to push the connecting lines back subsequently to accommodate them in the machine housing. This makes a particularly compact type of machine construction possible, especially since no additional space for the connecting lines has to be provided within the machine housing. The through-opening in the housing wall, opening out into the line channel, runs substantially perpendicularly in relation to the line channel and is suitably located on an end face or narrow side of the line channel that otherwise preferably extends in the axial direction along the machine housing.

While the connection pins are suitably coded with multiple possibilities with respect to the insulating bushes, the insulating bushes are advantageously uniquely coded with respect to the separating plate, and thereby fitted in it in an angle-coded manner. The angular increment is in this case suitably 45°. A special insulating bush assigned to a connecting or machine-connection line serving for equipotential bonding is expediently oriented outside the 45° increment.

The coded angular position of the insulating bushes with respect to the separating plate relates here to a through-opening in the machine housing that is common to the connecting lines, opens out into the line channel and is expediently off-center with respect to the longitudinal extent of the channel. With the coding system formed in such a way, a uniform alignment of the contact surfaces with respect to the separating plate, and consequently with respect to the machine, that are provided on the connection pins and are suitably planar can be realized with the required different alignments of the insulating bushes with respect to the separating plate.

The contact surfaces of the one pin head and a connection pin adjoining thereto and having a pin shaft are provided at the shaft end that protrudes from the separating plate on the upper side of the plate (outer side of the plate) facing away from the line channel. For this purpose, the connection pins are inserted into the insulating bushes in such a coded manner that the contact surfaces are suitably in line with one another and are uniformly aligned parallel to the longitudinal side of the plate.

For a unique angle coding of the insulating bushes, they suitably have at the same position a coding element that is preferably formed as an axial groove. This corresponds to a coding element which is provided on the underside of the separating plate and is preferably configured as a coding pin. The coding elements formed as an axial groove of the virtually identical insulating bushes are provided on a bush head on the outer circumference of the insulating bush and extend there over part of the length of the bush head. The axial grooves thereby also pass through an abutment collar, with which the insulating bush is supported on the separating plate, on the upper side thereof.

The bush head of the insulating bushes is adjoined by a hollow bush shaft, which forms the abutment collar and, to stabilize it against tilting, has at least one circumferential groove, but preferably two axially spaced-apart circumferential grooves, with sealing rings (O-rings) lying therein. Since the axial groove is provided in the likewise hollow bush head of the insulating bush and merely extends as far as the abutment collar, a coding pin fitted in a corresponding alignment pin bore of the separating plate does not collide with the sealing rings enclosing the insulating bush on the shaft side when the bush shaft of the insulating bushes is located in corresponding through-openings of the separating plate in a sealing and tilting-stabilized manner.

By analogy, the respective connection pin is also sealed with respect to the corresponding insulating bush. For this purpose, the connection pin in turn preferably bears two axially spaced-apart sealing rings, likewise in the form of O-rings, which lie in corresponding circumferential grooves of the pin shaft adjoining a pin head. To increase the reliability of the sealing effect, the seals of the insulating bushes with respect to the separating plate and of the connection pins with respect to the insulating bushes are therefore respectively realized by two static O-rings that are configured in a radially sealing manner. In comparison with a solution based on axially sealing O-rings, it is in this way possible in a simple way to realize a fixed axial stop that ensures that the connection pins cannot operate axially under changing pressure conditions. If the connection pins were to pass on the pressure-dependent axial forces occurring on account of axially compliant sealing elements, or if this were to lead to axial movements of the connection pins, this could result in changing mechanical stresses on and in the converter-side conductor bars that are brought into electrical contact with the contact surfaces of the connection pins. This in turn could lead to damage to the semiconductor modules that are likewise connected to the conductor bars, which must be avoided.

The insulating bushes have on the head side, i.e. in the region of the axial projection in the form of the bush head located on the inner side of the separating plate in the assembled state, a collar clearance in the form of a radial opening. In the assembled state there lie in these collar clearances connection elements which are preferably formed as cable lugs and with which the connection pins are brought into electrical contact on the inner side of the separating plate with the connecting lines lying there in the line channel. In the assembled state, the collar clearances are oriented in a way corresponding to the angle coding with respect to the separating plate in the direction of the through-opening for the connecting lines that is provided in the machine housing and opens out into the line channel.

Likewise on the head side, formed in the insulating bush there is a peripheral radial incision, and consequently a circumferential groove, by which the necessary air and creepage paths to the preferably metallic separating plate are ensured even in the region of the collar clearances of the insulating bushes. Furthermore, the insulating bushes have at the end face, on the bush head protruding axially beyond the separating plate on the inner side in the assembled state—and on the inner side there—, drawn-in coding recesses, in which edge regions provided on the head side of the connection pin engage in a way corresponding to the angular orientation.

For the contacting of the cable lugs connected to the ends of the connecting lines with respect to the connection pins, the latter have on the end face of the pin head that is located on the inner side of the separating plate in the assembled state a blind-hole threaded bore (internally threaded bore) for a fixing screw for the screw-contacting of the respective connecting lines or the cable lugs connected to the ends of said lines.

The insulating collar, which is interrupted at this point where the respective cable lug is led out radially from the collar clearance, serves the purpose of ensuring the required air and creepage paths from the connection pin, the cable lug and the fixing screw to a wall of the motor housing that is located in this region directly alongside the insulating bushes. The coding and associated unique orientation of these collar clearances of the insulating bushes with respect to the separating plate have the effect of reliably preventing that the insulating bushes can be wrongly turned during assembly in such a way that the required air and creepage paths with respect to the housing wall are not adequately provided.

In a preferred embodiment, the coding of the connection pins with respect to the insulating bushes is realized by the insulating bushes having at the end face in a step on the head side a milled relief that corresponds to two squares turned with respect to one another by 45°. The connection pins have on the head side a four-edged region that is adapted to the square clearances or milled reliefs. This makes possible a coding of the connection pins with respect to the insulating bushes with 8 possibilities altogether, and consequently multiple possibilities. For the production of these coding recesses, in particular by milling, rounded portions are suitably provided in the corners. The connection pins engage by their square four-edged region in these milled reliefs. The required rounded corner portions of the milled reliefs are provided on the respective connection pin by the square four-edged region being bounded radially on the outside by a cylindrical enveloping surface. This allows a blank with a comparatively small diameter to be used.

While the pin shaft of the connection pin can be inserted into the insulating bush in any desired rotational orientation with respect thereto, the head-side four-edged region of the connection pin can be fitted into the milled coding recesses of the insulating bush only in eight angular positions. As a result, it is possible to arrange the insulating bush itself with respect to the separating plate in eight different discrete angular positions, in order to achieve a uniform alignment of the shaft-side contact surfaces of the connection pins with respect to the separating plate.

The insulating bushes and the connection pins are configured in such a way that they can be respectively inserted from the inner side of the separating plate that is subjected to pressure in the assembled state. Corresponding bush flanges or pin flanges thereby abut axially, so that on the one hand the insulating bushes are axially positioned uniquely with respect to the separating plate and on the other hand the connection pins are axially positioned uniquely with respect to the insulating bushes. On the outer side or upper side of the insulating plate that is opposite from the line channel for receiving the connection lines, the connection pins and the insulating bushes are merely fixed by outer securing rings. Consequently, neither the insulating bushes can be forced back with respect to the separating plate nor the connection pins can be forced back with respect to the insulating bushes in the direction of the line channel. For receiving these outer securing rings, a circumferential groove is respectively incorporated on the one hand in the bush shaft of the insulating bushes protruding beyond the separating plate on the outer side of the plate and on the other hand in the pin shaft of the connection pins protruding in turn therefrom. During the operation of the electrical machine, these outer securing rings are axially free from forces on account of the different pressure conditions on the inner side and outer side of the separating plate.

The sealing of the connection pins with respect to the insulating bushes and the sealing thereof with respect to the separating plate respectively takes place by two radially sealing O-rings. For easy production and assembly, the required radial circumferential grooves are always made as outer incisions in the connection pins on the one hand and in the insulating bushes on the other hand. On account of the double configuration of the O-rings, in addition to greater immunity to leakages as a result of the radially applied elastic force at two different axial positions in each case, a coaxial self-alignment of the lateral cylindrical surfaces of the sealing regions on the pin and on the bush with respect to one another is achieved independently of the temperature-dependently fluctuating tolerances of fit.

In an advantageous configuration, the machine housing of the electrical machine has a mounting platform. The mounting platform is expediently closed by a hood-like housing, which in the manner of a terminal box merely receives connection elements or else comparatively complex electronics, for example converter components. The housing seals off the mounting platform (as a dry interface) from the outside. For this purpose, the mounting platform, which is aligned tangentially in the case of a cylindrical machine housing, forms a peripheral, and for example substantially rectangular, sealing surface. Within the mounting platform there are suitably also inlet and outlet openings for the cooling medium. These may be configured as stubs or pipes, which are in connection with fluid chambers or channels within the machine housing.

Consequently, the mounting platform is suitably a virtually integral component part of the machine housing and, in particular in the case of a cylindrical machine housing, is formed by a platform frame, which is for example rectangular and is joined onto the housing wall of the machine housing on the outside with a material bond, in particular by welding, or else by being formed as one part. A mounting platform formed in such a way on a cylindrical machine housing forms a housing interstice respectively on opposite longitudinal sides of the housing. This housing interstice is advantageously used as a space forming the line channel, in order to lay the connecting lines or machine connections there.

The advantages achieved with the invention are, in particular, that the coding according to the invention of the connection pins with respect to the insulating bushes receiving them allows a uniform alignment of the connection pins to be ensured. Since the insulating bushes are preferably also coded with respect to the separating plate, they can be fitted in the separating plate with unique, but different angle codings, and at the same time a uniform alignment of the connection pins arranged therein can be ensured.

The separating plate consisting of metal with, fitted therein, the insulating bushes, preferably consisting of plastic, and the connection pins, in turn of metal, is suitable as a connection lead-through, particularly for an electric motor or generator with a directly oil-cooled stator winding and pressure-tight lead-through of the electrical connections, in order to allow the motor or generator to be electrically connected to a converter. The coding system between the insulating bushes and the separating plate on the one hand and the connection pins and the insulating bushes on the other hand makes possible a uniform orientation of the contact surfaces of the connection pins at a predetermined angle with respect to the separating plate, and consequently with respect to the electrical machine.

The angle coding of the insulating bushes with respect to the separating plate, which is predetermined but assumes different, discrete values in the case of the individual insulating bushes, not only serves for maintaining the air and creepage paths. Rather, this angle coding of the insulating bushes also serves for making assembly easier, by specifically oriented laying of the connecting lines within the line channel and contacting thereof at the ends in the form of cable lugs at the ends of the connecting lines that are led through correspondingly suitable outward opening of the insulating bushes to the connection pins.

On account of the high radial sealing effect of the sealing elements between the separating plate and the insulating bushes on the one hand and between these and the connection pins on the other hand, the inner machine region on one side of the separating plate is closed off in a reliably pressure-tight manner from the outer machine region on the other side of the separating plate. In this case, both the sealing region and the coding region of the separating plate with the fitted insulating bushes and the connection pins in turn inserted therein are constructed in an axially and radially particularly compact manner. For reasons of cost and overall space, the plate thickness of the separating plate is already adapted here to the requirements necessary for the compressive stress and the elementary accommodation of the sealing. Moreover, the geometry and the configuration of the insulating bushes on the one hand and of the connection pins on the other hand are designed for production at lowest possible cost.

The coding system with the unique coding of the insulating bushes with respect to the separating plate and an angular orientation of the connection pins with multiple possibilities with respect to the insulating bushes makes possible an arrangement in which the effective spatial regions of the angle coding of the insulating bushes with respect to the separating plate and the sealing of the insulating bushes with respect to the separating plate may overlap axially by being arranged radially at different diameters. This makes it possible to make the separating plate relatively thin-walled, in order in this way to save overall space axially. The overall spaces of the coding of the connection pins with respect to the insulating bushes and of the insulating bushes with respect to the separating plate likewise overlap axially to minimize the overall length as a whole and are in turn separated by the effective regions lying on different pitch circles.

In order to minimize the diameter of the arrangement, and thereby ensure a sufficient material cross section for conducting the current at every point along the pin, the sealing of the connection pins with respect to the insulating bushes is arranged axially offset in relation to an internal or blind-hole thread at the end face in the connection pin. The blind-hole thread is required in order to fasten the connecting lines of the machine on the inner machine side of the separating plate. For this purpose, the sealing region is arranged in such a way that it does not take up any overall space axially outside the axial projection of the insulating bushes with respect to the separating plate in the outer region, which is required in any case for maintaining the necessary air and creepage paths. The spatial nesting of the coding and sealing regions also makes a particularly compact structure possible.

The unique angle coding of the insulating bushes ensures that the required air and creepage paths on the inner side of the separating plate with respect to the machine housing cannot fail to be adequately provided because of assembly errors. At the same time, a uniform angular alignment of the lateral contact regions of the connection pins in the form of their contact surfaces with respect to the separating plate is made possible even though the insulating bushes in which the connection pins are arranged have different discrete angular orientations in their final assembled state within the separating plate.

The electrical machine according to the invention with the machine housing according to the invention is suitably a motor or generator with a power output in the range between 1 kW and 1000 kW, in particular 2 kW to 500 kW, preferably 3 kW to 200 kW, for example 100 kW to 140 kW, which is expediently used as a drive operating on the principle of a motor or a generator for a unit of an in particular mobile commercial vehicle.

Other features which are considered as characteristic for the invention are set forth in the appended claims.

Although the invention is illustrated and described herein as embodied in an electrical machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal sectional view of an electrical machine, with a machine housing with a line channel and connections and connecting lines arranged therein according to the invention;

FIG. 2 is a is a diagrammatic, top perspective view of the electrical machine according to FIG. 1;

FIG. 3 is a diagrammatic, perspective view of the electrical machine according to FIG. 1, with a separating plate swung over one narrow side;

FIG. 4 is a plan view of a separating plate, with, fitted therein in various angular positions, insulating bushes with inserted connection pins;

FIG. 5 is a perspective view of the separating plate with a view of an upper side of the plate (outer side of the plate);

FIG. 6 is a bottom plan view of the separating plate without insulating pins, with a view of the underside of the plate (inner side of the plate);

FIG. 7 is a cross-sectional view, partly perspectively, along an insulating bush with inserted connection pins that is fitted in the separating plate;

FIGS. 8 and 9 are perspective views showing the insulating bush in a perspective side view and end-on view, respectively;

FIGS. 10 and 11 are perspective views of the connection pin, with and without a screw-contacted cable lug and outer securing ring;

FIG. 12 is a perspective view of the electrical machine, with integrated power electronics; and

FIG. 13 is a perspective view of the electrical machine according to FIG. 12, with the electronics housing lifted off from the machine housing.

### DETAILED DESCRIPTION OF THE INVENTION

Parts that correspond to one another are provided with the same designations in all the figures.

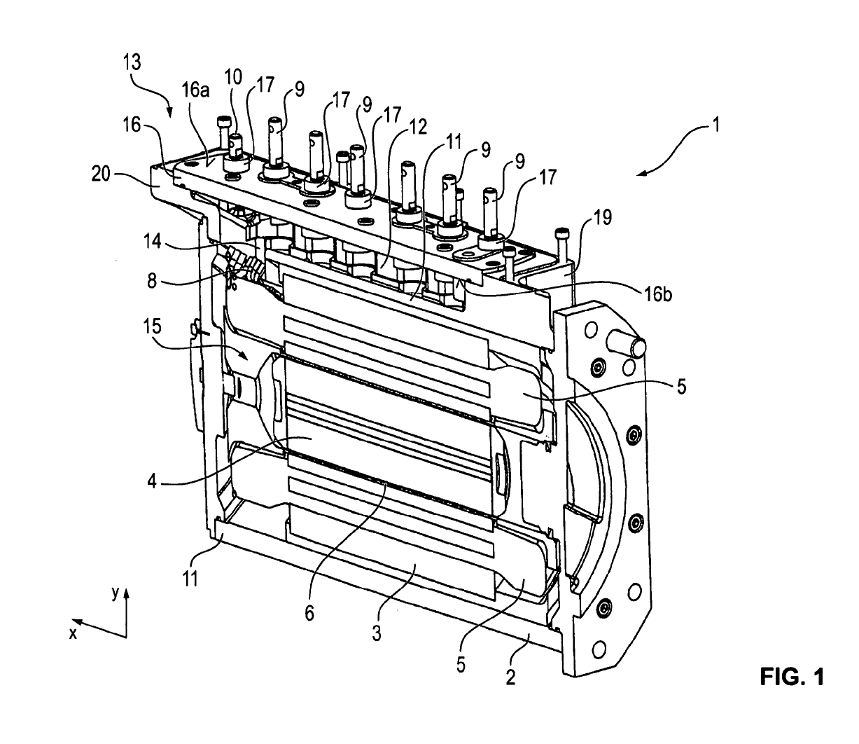

FIGS. 1 to 3 show an electrical machine, for example a six-phase electrical machine 1, with a machine housing 2, in which a stator 3 and a rotor 4 are arranged. The stator 3 bears coil windings (stator windings) 5 and is hermetically sealed with respect to the rotor 4 within the machine housing 2, for example by a split tube 6 for the cooling of the stator by a suitable fluid, in particular oil. The rotor 4, provided with permanent magnets in a way that is not represented any more specifically, sits on a shaft 7 that is mounted in the machine housing 2 and is led out from the latter at the end. The stator windings 5 are connected by way of connecting lines 8 to connection pins 9, serving as machine connections (phase connections), for making electrical contact with the windings 5. A further connection pin 10, which is likewise led by way of a connecting line 8 to the stator 3, serves for equipotential bonding.

A line channel 12 is provided on the outside of a housing wall 11 of the machine housing 2. According to the system of Cartesian coordinates represented the line channel 12 extends in the longitudinal direction of the housing (axial direction) x. In the line channel 12 lie the connecting lines 8. At one of its longitudinal ends 13, there opens out into the line channel 12 a through-opening 14, which is incorporated in the housing wall 11 of the machine housing 12 at the corresponding point. In the region of the through-opening 14, the connecting lines 8 are bent away approximately or substantially at right angles. The through-opening 14 and the line channel 12 run substantially perpendicularly in relation to one another. The connecting lines 8 are consequently led out from the interior space (interior machine space) 15 of the machine housing 2 housing-internally by way of the through-opening 14 and bent around into the line channel 12.

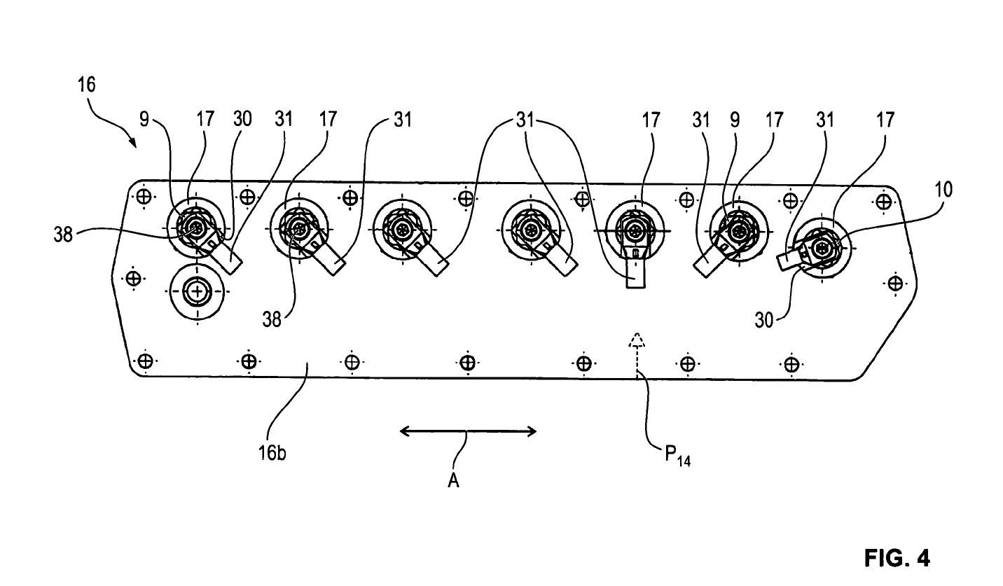

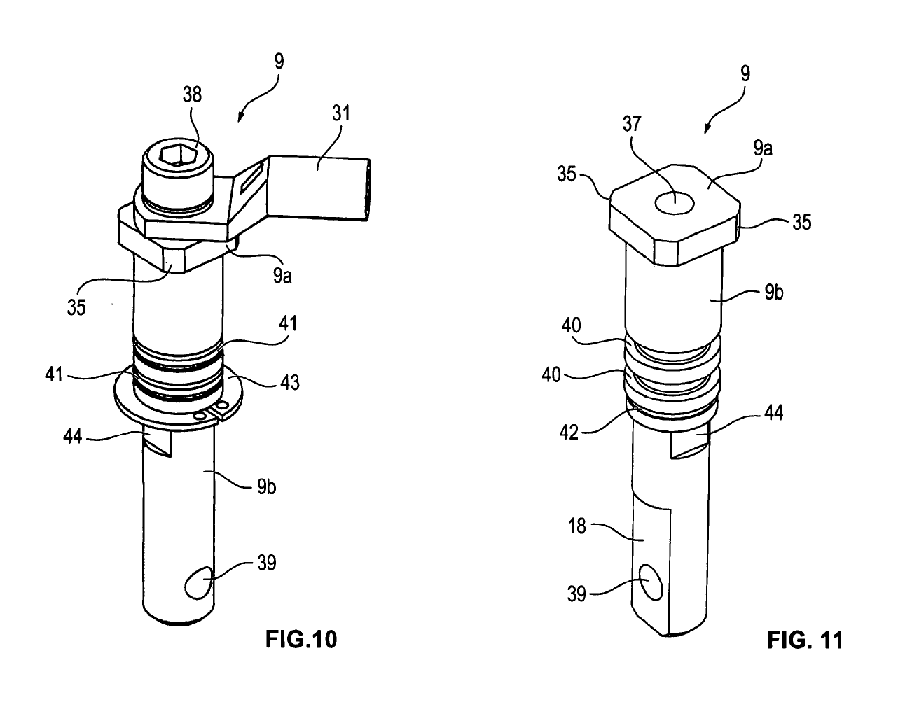

The line channel 12 is covered on the outer side, lying opposite from the housing wall 11, by a separating or mounting plate 16 consisting of metal, in particular of aluminum or high-grade steel. Fitted in the separating plate 16 are insulating bushes 17, which are produced in particular from plastic. Inserted in these in turn are the connection pins 9, 10. The connection pins are joined onto the ends of the connecting lines 8, such that they run at right angles and are electrically conducting, and for this purpose are screwed to the connecting lines 8 in particular by way of cable lugs (FIGS. 4 and 10), crimping eyelets or the like. The connection pins 9, 10 protrude on the upper or outer side 16a of the separating plate 16 that is facing away from the line channel 12 from the plate and form contact surfaces 18 there. The separating plate 16, the underside 16b of which is facing the line channel 12 and the interior machine space 15, closes the line channel 12 in a pressure-tight manner and forms an electrical and/or mechanical interface with respect to power or converter electronics that are not represented.

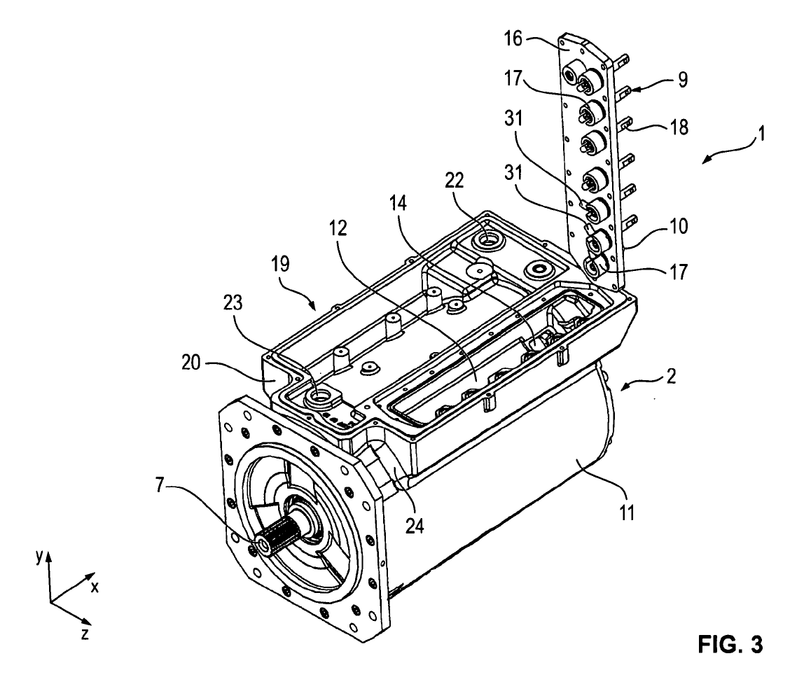

As can be seen comparatively clearly from FIG. 3, the line channel 12 is an (integral) component part of a mounting platform 19. In the case of the cylindrical machine housing 2 in the exemplary embodiment, this platform is oriented tangentially and, according to the system of coordinates represented, lies in the xz plane. The mounting platform 19 is substantially formed by a housing frame 20, which is circumferentially closed and is joined with a material bond or as one part onto the cylindrical machine housing 2 or the housing wall 11 thereof, for example by welding.

The machine platform 19 or the housing frame 20 thereof forms a circumferentially closed sealing surface or sealing edge 21. Within the mounting platform 19 enclosed by the sealing surface 21 there is the line channel 12 and—outside the line channel 12—coolant outlets and coolant inlets (coolant stubs or pipes) 22, 23. These open out into the interior machine space 15 or open out from the latter into the mounting platform 19. On account of this structural design, consequently the housing frame 20 and the mounting platform 19 as well as the line channel 12 are virtually an integral component part of the machine housing 2.

On account of the way in which the mounting platform 19 with its housing frame 20 is structurally joined onto the cylindrical housing wall 11 of the machine housing 2, a housing interstice 24 is formed between the housing wall 20 and the mounting platform 19. This interstice is consequently likewise an integral component part of the machine housing 2. In this housing interstice 24, a sufficiently large overall volume for the line channel 12 is provided, so that, even in the case of a three-phase electrical machine 1, the number of connecting lines 8 required as a result can lie there in a space-saving manner. This makes a particularly compact type of construction of the machine housing 2, and consequently of the electrical machine 1, possible overall, with at the same time great flexibility.

The separating plate 16, swung open (swiveled) on the narrow side by way of example in FIG. 3, makes possible easy-installation laying of the connecting lines 8 within the line channel 12 and easy-to-handle and reliable insertion of the insulating bushes 17 and the connection pins 9, 10 through the associated through-openings (FIG. 6) in the separating plate 16. The connecting lines (machine-connection cables or lines) 8 are configured as stranded lines that are sheathed for insulating purposes and have, in particular in the case of a high machine power output, a large conductor cross section of 10 mm2 to 70 mm2.

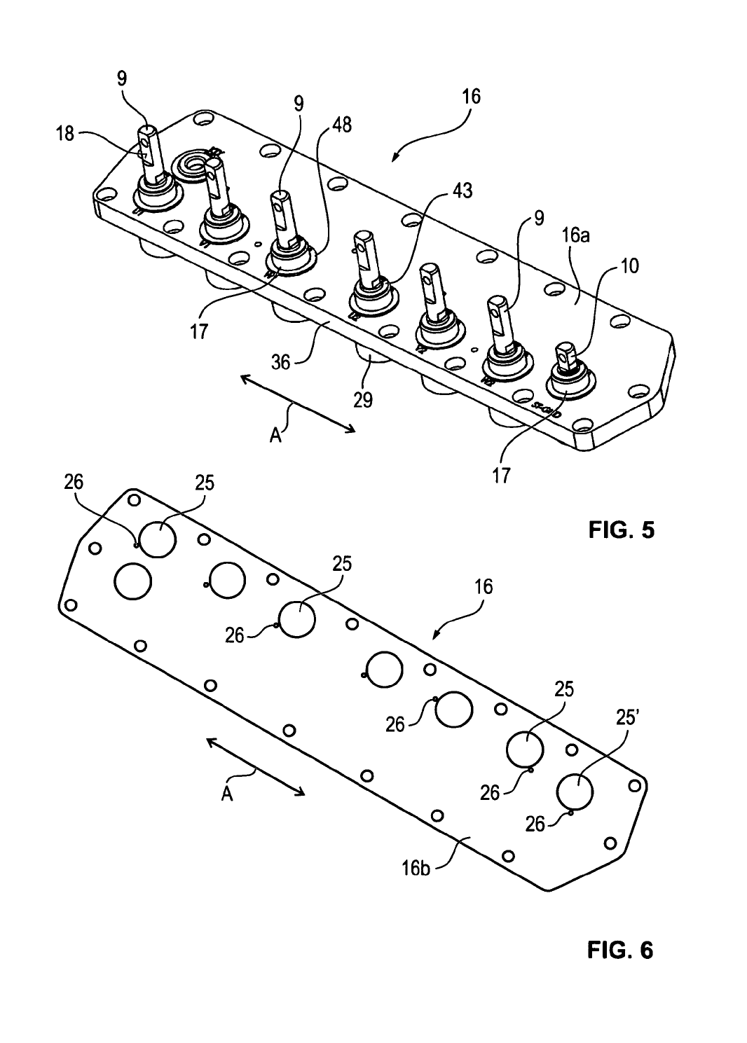

FIGS. 4 to 6 show the separating plate 16, consisting of metal, with and without insulating bushes 17 fitted therein and connection pins 9, 10 in turn inserted therein. FIGS. 4 and 6 thereby show the separating plate 16 with a view of the underside 16b thereof, which in the assembled state is facing the line channel 12. FIG. 5 on the other hand shows the separating plate 16 with a view of the upper side or outer side 16a thereof. The separating plate 16 has a number of insertion openings 25, 25′, corresponding to the number of insulating bushes 17 and connection pins 9, 10 assigned to the latter, of which openings the insertion opening 25′ that is assigned to the insulating bush 17 receiving the connection pin 10 for the equipotential bonding is set back slightly from the line of alignment of the other insertion openings 25.

In the statements made below, for the sake of simplicity reference is made only to the connection pin 9 and the insertion openings 25, while the identical connection pin 10 and the identical insertion opening 25′ are only explicitly mentioned when details differ.

It is evident that each insertion opening 25, and consequently each insertion bush 17 fitted therein according to FIGS. 4 and 5, is assigned a coding opening 26 in the form of a blind-hole bore. The coding openings 26, serving as plate-side coding elements, are circumferentially assigned to the respective insertion opening 25 partly at the same positions and partly at different positions. The coding openings 26 are moreover arranged as close as possible to the rim of the respective insertion opening 25.

It is evident that, of the altogether seven insertion openings 25, 25′, the first four openings 25 from the left in FIG. 6 are positioned at an angle of (−)45° with respect to the represented longitudinal axis A of the plate, while the coding opening 25 of the next-following insertion opening 26 is located in this respect at the 0° position. The position of the coding opening 26 of the insertion opening 25 adjacent the insertion opening 25′ is located with respect to the longitudinal axis A of the plate at the (+)45° position. For the coding openings 26 of these six insertion openings 25, this produces a 45° increment. Only the coding opening 26 assigned to the insertion opening 25′ deviates from this, its angle lying outside the 45° increment.

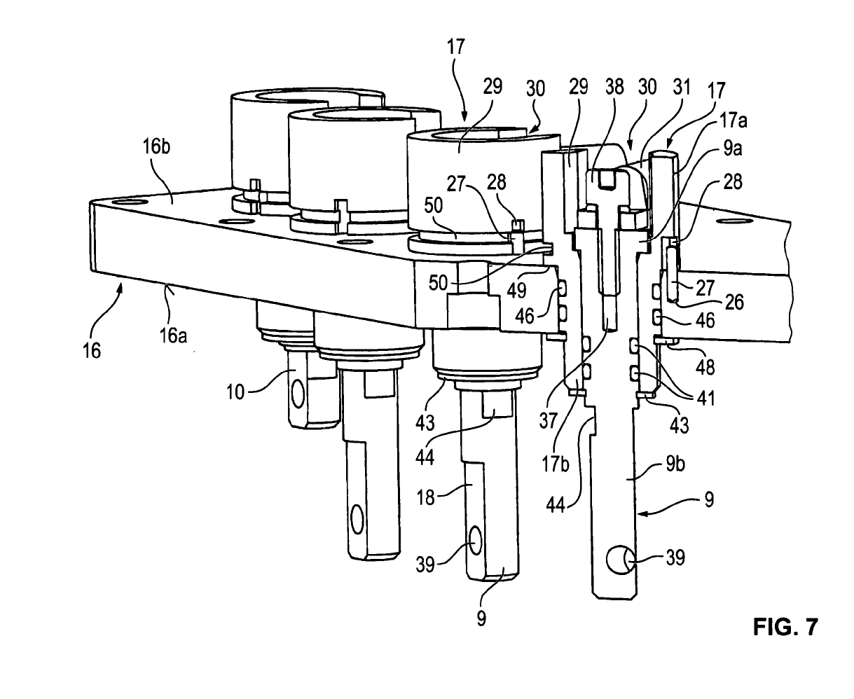

As can be seen from FIG. 7, the plate-side coding openings 26 respectively receive a coding pin 27, which pins protrude from the separating plate 16 on the underside 16b thereof. In the case of insulating bush 17 fitted in the respective insertion opening 26, 26′, the respective coding pin 27 engages in a bush-side coding groove 28, which extends on the outside in the longitudinal direction of the insulating bush 17 over part of the head 17a thereof.

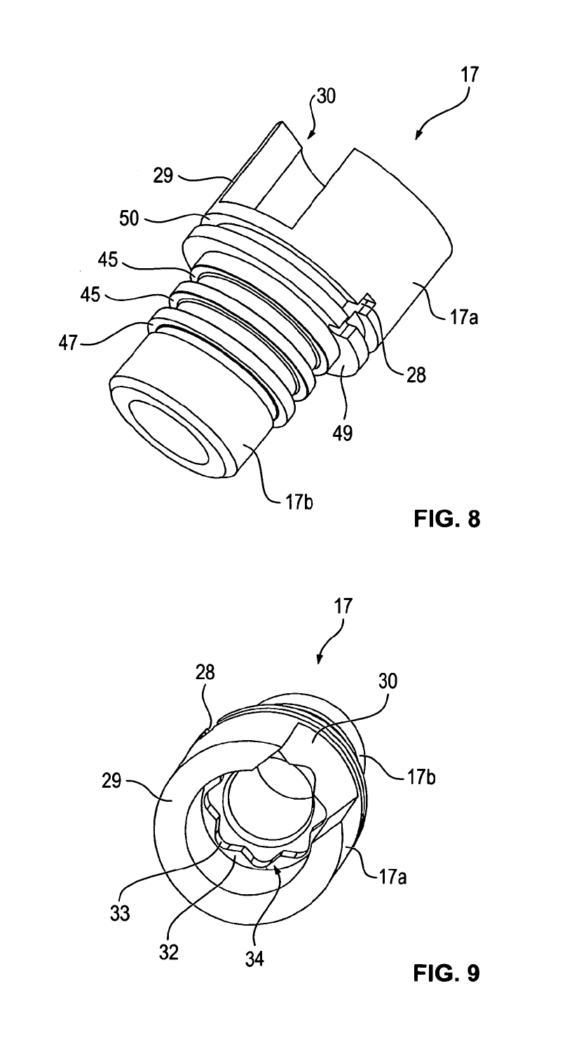

As FIG. 8 shows in particular, the coding groove 28 is located as a bush-side coding element on the outer circumference 5 of the bush head 17a, with which the insulating bush 17 protrudes from the separating plate 16 on the inner side 16b of the plate and protrudes into the line channel 12. On the head side, the insulating bush 17 forms a bush collar or insulating collar 29. Incorporated in this is an approximately U-shaped collar clearance 30 that is open at the end face. In the inserted assembly position, the plate-side coding pin 27 engages in the bush-side coding groove 28. Depending on the particular insertion opening 25, 25′ in which the identical insulating bushes 17 are inserted, the orientation of the collar clearance 30, and consequently the angular position thereof, with respect to the separating plate 16 or the longitudinal direction A thereof is determined.

Accordingly, in the final assembled state according to FIG. 4, the insulating bushes 17 have been inserted into the separating plate 16 in an angle-coded manner with respect thereto. On the one hand, the angular orientation of the collar clearances 30 of the insulating bushes 17 is in this case aligned as optimally as possible with the position P14, illustrated in FIG. 4, of the through-opening 14 located underneath the separating plate 16 in the line channel 12 of the machine housing 2. As a result, only a bending that is as small as possible of the individual connecting lines 8 that are led by way of the common through-opening 14 into the line channel 12 is required in order to lead them to the connection pins 9, 10. On the other hand, this angular positioning or orientation of the insulating bushes 17 and the collar clearances 30 thereof ensures that the required air and creepage paths are maintained.

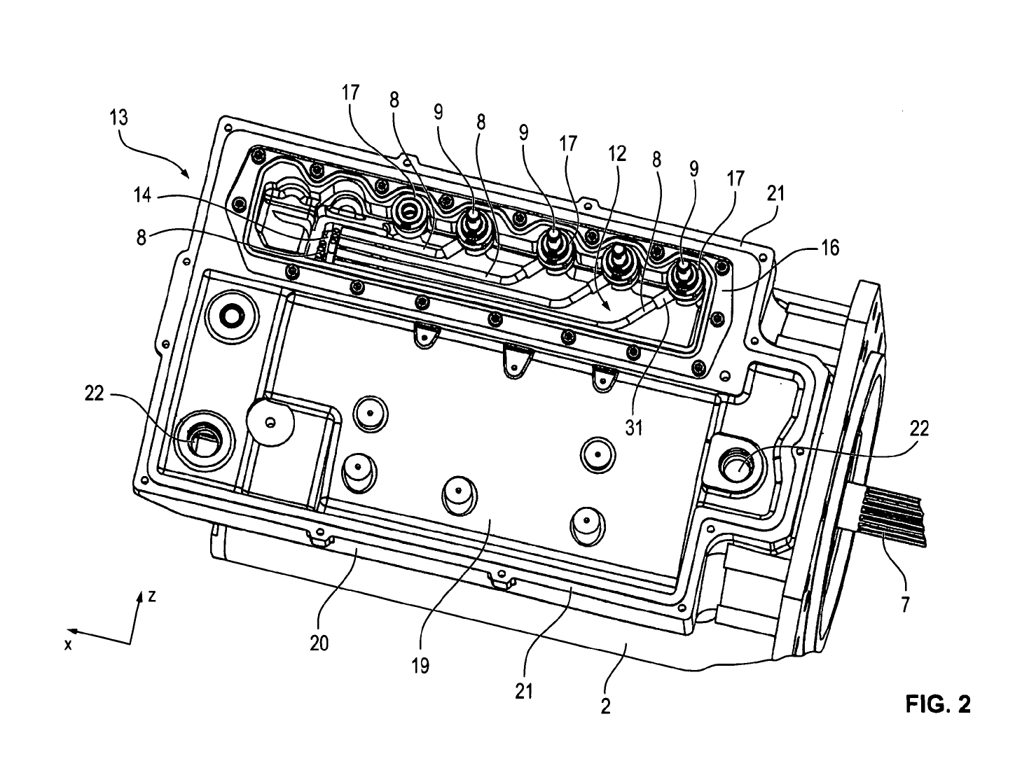

As is evident comparatively clearly from FIGS. 4 and 7, cable lugs 31 brought into electrical contact with the connection pins 9 pass through the respective collar opening 30 of the insulating bushes 17. It can be seen from FIG. 2, in which the separating plate 16 is represented as transparent, that the cable lugs 31 are connected to the ends of the connecting lines 8 in a mechanically and electrically conducting manner. Also evident in particular in FIG. 4 is the 45° increment of the coding or orientation of the collar openings 30, and consequently of the cable lugs 31 led through them. Only that insulating bush 17 that is assigned to the connection pin 10 intended for the equipotential bonding deviates from this 45° increment in the exemplary embodiment.

While the angle coding of the insulating bushes 17 with respect to the separating plate 16 is uniquely determined by the predetermined position of the respective coding pin 27 at the circumference of the insertion openings 25 of the separating plate 16, the connection pins 9 may be fitted into the respective insulating bush 17 in a total of eight different angular positions, and coded in this way. Consequently, a 45° increment is likewise obtained for the coding of the connection pins 9, 10 with multiple possibilities with respect to the respective insulating bush 17.

As FIG. 9 shows, for this purpose each of the hollow-cylindrical insulating bushes 17 has on the head side a drawn-in step 32, incorporated in which are a total of eight approximately V-shaped, for example milled, coding contours 33, which as a whole form a star-shaped coding recess 34. This star-shaped contour of the coding recess 34 consists of two approximately square milled reliefs turned with respect to one another by 45°. In this case, the corners of these square milled reliefs are rounded to form the approximately V-shaped coding contours 33.

Engaging in the coding recess 34 of the insulating pin 17 is a correspondingly square-formed pin head 9a of the connection pin 9. In this case, the square four-edged region of the pin head 9a is beveled or rounded in the corner regions 35 thereof in such a way that the required rounded corner portions of the coding contours (milled reliefs) 33 are provided on the connection pins 9. For this purpose, the square four-edged region of the connection pins 9 on the head side is bounded radially on the outside by a cylindrical hollow surface. On account of this substantially square configuration of the connection pins 9 on the head side and the star-shaped coding recess 34 of the insulating bush 17, the connection pin 9 can be inserted into the insulating bush 17 in a total of eight angular positions with respect thereto. In this case, the respective connection pin 9, 10 assumes with respect to the insulating bush 17 in the assembled state that angular position in which the planar contact surface 18 provided at the shaft end side on the connection pin 9, 10 is aligned parallel to the longitudinal edge 36 of the separating plate 16 in such a way that the contact surfaces 18 of all the connection pins 9, 10 are in line with one another, as can be seen in particular in FIG. 5.

Accessible on the head side, and thereby from the end face of the connection pin 9, there is incorporated in the latter an internally threaded or blind-hole threaded bore 37. According to FIG. 10, a fixing screw 38 for clamping-contacting of the cable lug 31, and consequently for the electrically conducting connection of the connecting lines 8 to the connection pins 9, 10, is screwed into the threaded bore 37. The radial orientation of the cable lug 31 with respect to the respective connection pin 9, 10 is in this case determined by the position of the collar clearance 30 of the respective insulating bush 17, and consequently the angle coding thereof with respect to the separating plate 16. In the assembled state, the connecting lines 8 and the cable lugs 31 run substantially at right angles to the connection pins 9, 10.

According to FIGS. 7, 10 and 11, the pin head 9a of the connection pins 9 is adjoined by a pin shaft 9b, at the shaft end of which the planar contact surface 18 is provided. A threaded bore or screw opening 39 is incorporated there. This serves for the contacting of the connection pins 9 with, for example, a conductor bar of electronics not represented any more specifically, for example of a converter. In the region between the pin head 9a and the contact surface 18, two axially spaced-apart circumferential grooves 40 for receiving sealing rings 41 (O-rings) are incorporated in the pin shaft 9b. A further circumferential groove 42, provided underneath these circumferential grooves 40 in the direction of the contact surface 18, serves for receiving an outer securing ring 43. With this outer securing ring 43, the connection pin 9, 10, in the insulating bush 17 in a sealing manner and stabilized against tilting on account of the two sealing rings (O-rings) 41 arranged axially one above the other, is axially secured against axial displacement with respect to the insulating bush 17. Between the circumferential groove 42 for the outer securing ring 43 and the contact surface 18 there is in the pin shaft 9b of the connection pin 9 a wrench flat 44 for a handling tool in the form of an open-end wrench, as a counter-support when tightening the fixing screw 38.

By analogy, according to FIGS. 7 to 10, the insulating bush 17 has also been inserted into the respective insertion opening 25 of the separating plate 16 in a radially sealing and tilting-stabilized manner. For this purpose, the insulating bush 17 has in turn in its bush shaft 17b adjoining the bush head 17a radially spaced-apart circumferential grooves 45, in which in turn sealing rings or elements 46 in the form of O-rings are fitted. In the direction of the shaft end of the insulating bush 17, a further circumferential groove 47 is incorporated in the shaft 17b thereof. In the final assembled state shown in FIG. 7, this groove likewise receives an outer securing ring 48 for the axial securing of the insulating bush 17 with respect to the separating plate 16.

On account of the comparatively large outside diameter of the bush head 17b, in comparison with the bush shaft 17b, of the insulating bush 17 produced as a plastic molding, formed on the head is an abutment collar 49, with which the insulating bush 17 is supported on the rim of the respective insertion opening 25 on the underside 16b of the separating plate (FIG. 7). A further circumferential groove 50 is incorporated in the insulating bush 17 above the abutment collar 49 and below the head-side collar clearance 30. The groove serves for increasing the air and creepage paths.

The invention consequently relates to an electrical machine 1 with a machine housing 2 for receiving a stator 3 and a rotor 4 with stator and/or rotor windings 5, which are connected to connecting lines 8 for making electrical connection contact. A separating plate 16, covering a line channel 12 for receiving the connecting lines 8, has a number of insulating bushes 17, inserted in which are connection pins 9, 10 that can be brought into electrical contact with the connecting lines 8. In this case, the connection pins 9, 10 are inserted in the insulating bushes 17 in a position-coded or angle-coded manner with respect thereto and preferably the insulating bushes 17 are inserted in the separating plate 16 in a position-coded or angle-coded manner with respect thereto.

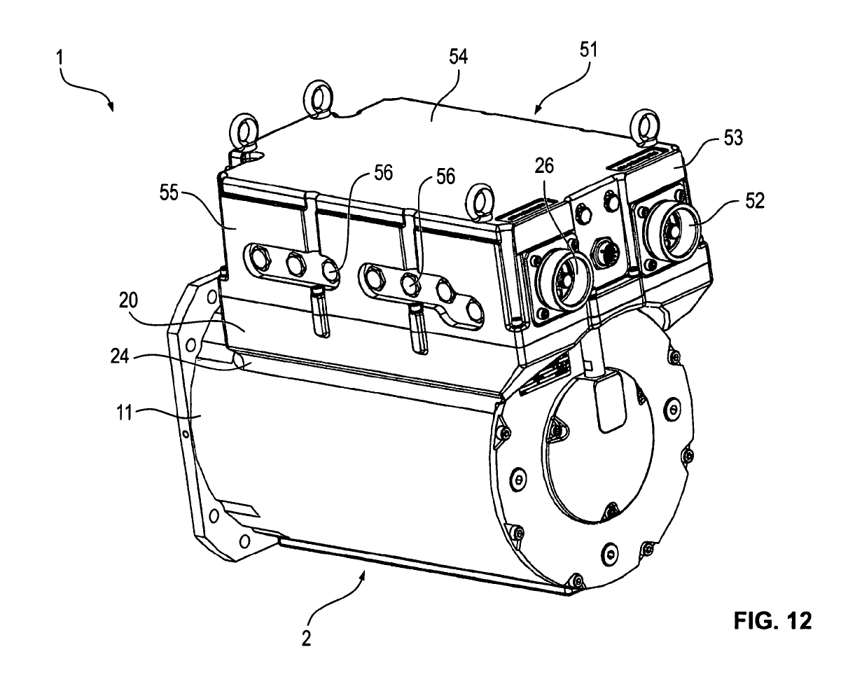

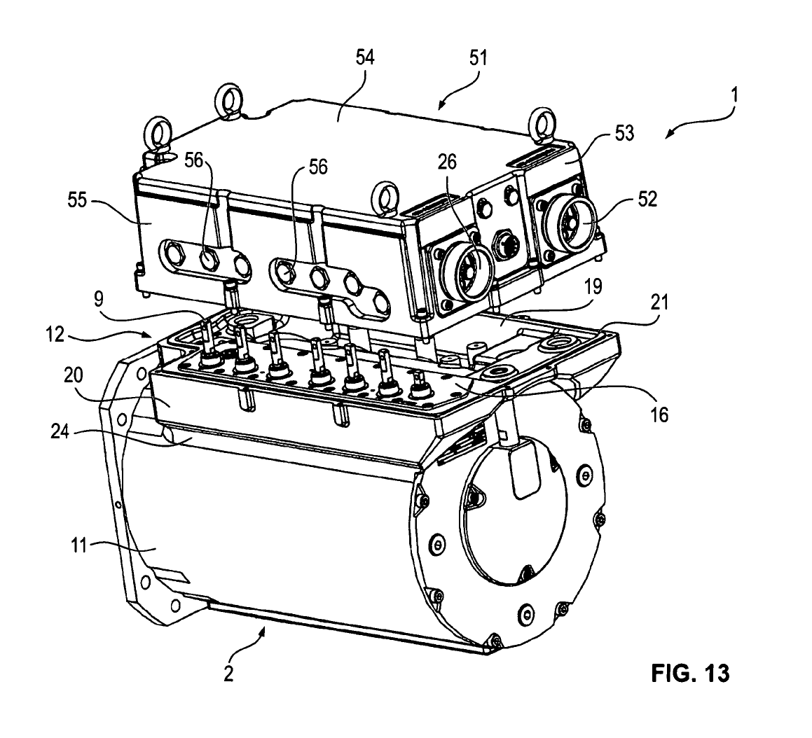

FIGS. 12 and 13 show the electrical machine 1 with integrated power electronics 51. The power electronics 51 operate for example as converters and convert alternating current (AC) on the machine side into direct current (DC) on the output side of the electronics. For this purpose, semiconductor switches, for example IGBTs, can be interconnected in a bridge circuit in a manner known per se and activated as intended on the control input side (gate side). The electrical machine 1 may in this case operate as a generator or as a motor. In the operating mode thereof as a motor, the electronics 51 are fed a direct voltage or direct current by way of housing-side, combined power and coolant connections (oil connections) 52, while during operation as a generator a direct current that is correspondingly produced on a generator principle can be tapped at these combined power and coolant connections 52 and for example be fed into an intermediate circuit.

During operation as a generator, the electrical machine 1 serves for example for feeding power back into an on-board system of an in particular also mobile commercial vehicle or for operating a vehicle unit. In the operating mode as a motor, the electronics 51 are operated with a direct voltage from the conventional DC on-board system of the commercial vehicle, in order to drive a unit of the commercial vehicle.

While the combined power and coolant connections 52 are advantageously arranged on a narrow side or end face 53 of the electronics or converter housing 54, the longitudinal side 55 of the electronics or converter housing 54 that is facing the line channel 12, and consequently the separating plate 16, serves for the arrangement of contact connections 56, which are expediently configured as screw contacts or plug-in contacts. These serve for the electrical contacting and mechanical fixing of the connection pins 9 with the power electronics 51, in order to establish the electrical connection (transfer) to the electronics 51.

For this purpose, following the laying of the connecting lines 8 in the line channel 12 and the subsequent pressure-tight covering thereof by means of the separating plate 16, the housing 54, containing the electronics 51 or merely terminal-box-like connections, is placed onto the mounting platform 19 and screwed to it. In this case, the connections 9 and on the longitudinal side of the machine housing 2, running in the x direction, are transferred to the electronics 51 by way of the separating plate 16 (of the or on the mounting platform 19).

Altogether, consequently, a particularly compact and at the same time highly functional electrical machine 1 is provided, the assembly of which—including for service purposes—can be handled particularly easily and reliably and is therefore particularly easy in terms of installation. The separating plate 16 thereby forms as it were a pressure-tight and/or fluid-tight interface between the connection pins 9, serving as machine connections or contacts, and the electronics (converter or transformer electronics) 51.

The invention is not restricted to the embodiment described above. Rather, other variants of the invention can also be derived from it by a person skilled in the art without departing from the subject matter of the invention. In particular, furthermore, all of the individual features described can also be combined with one another in another way without departing from the subject matter of the invention.

### LIST OF DESIGNATIONS

1 machine
2 machine housing
3 stator
4 rotor
5 coil/stator winding
6 split tube
7 shaft
8 connecting line
9 connection pin
9a pin head
9b pin shaft
10 connection pin
11 housing wall
12 line channel
13 longitudinal end
14 through-opening
15 interior space
16 separating plate
16a upper side/outer side of the plate
16b underside/inner side of the plate
17 insulating bush
17a bush head
17b bush shaft
18 contact surface
19 mounting platform
20 housing frame
21 sealing surface/edge
22 coolant outlet
23 coolant inlet
24 housing interstice
25,25′ insertion opening
26 coding opening
27 coding pin/element
28 axial groove/coding element
29 bush/insulating collar
30 collar clearance
31 cable lug
32 step
33 coding contour
34 coding recess
35 corner region
36 longitudinal edge of the plate
37 threaded bore
38 fixing screw
39 threaded bore
40 circumferential groove
41 sealing ring
42 circumferential groove
43 outer securing ring
44 wrench flat
45 circumferential groove
46 sealing element
47 circumferential groove
48 outer securing ring
49 abutment collar
50 circumferential groove
51 electronics/converter
52 power/coolant connection
53 narrow side
54 electronics/converter housing
55 longitudinal side
56 contact connection

1. An electrical machine, comprising:
a stator;
a rotor;
coil windings;
connecting lines;
a machine housing for receiving said stator, said rotor and said coil windings, said coil windings connected to said connecting lines for making electrical connection contact;
a line channel receiving said connecting lines;
a separating plate covering said line channel;
a number of insulating bushes; and
connection pins inserted in said insulating bushes in a position-coded manner, said connection pins being in electrical contact with said connecting lines.

2. The electrical machine according to claim 1, wherein said insulating bushes are inserted in said separating plate in an angle-coded manner with respect thereto.

3. The electrical machine according to claim 1, wherein:
said insulating bushes have at a same position in each case a first coding element; and
said separating plate having an underside with a second coding element corresponding to said first coding element.

4. The electrical machine according to claim 1, wherein:
said separating plate has an inserting opening formed therein and an upper side; and
said insulating bushes has a hollow bush shaft, which passes through said insertion opening of said separating plate, and a bush head, which is formed onto said hollow bush shaft and forms an abutment collar supported on said upper side of said separating plate.

5. The electrical machine according to claim 4, wherein to stabilize said insulating bushes against tilting, said insulating bushes have on a shaft side at least one circumferential groove formed therein, and a sealing ring disposed in said circumferential groove.

6. The electrical machine according to claim 4, wherein to secure an axial position of said insulating bushes with respect to said separating plate, said insulating bushes have on a shaft side a circumferential groove formed therein for an outer securing ring.

7. The electrical machine according to claim 1, wherein said insulating bushes have a head side with a circumferential groove formed therein providing an air and creepage path.

8. The electrical machine according to claim 1, wherein:
said machine housing has a through-opening formed therein for said connecting lines and opens out into said line channel; and
each of said insulating bushes have a collar clearance, which is oriented in a way corresponding to an angle coding with respect to said separating plate in a direction of said through-opening.

9. The electrical machine according to claim 1, wherein:
said insulating bushes have an inner side with drawn-in coding recesses formed therein; and
said connecting pins have a head side with edge regions, said edge regions engage in said drawn-in coding recesses in a way corresponding to an angle coding.

10. The electrical machine according to claim 9, wherein said insulating bushes have said drawn-in coding recesses formed by two square clearances turned with respect to one another by 45°.

11. The electrical machine according to claim 10, wherein said connection pins have on said head side a four-edged region that is adapted to said square clearances.

12. The electrical machine according to claim 1, wherein said connection pins have a pin head and a pin shaft adjoining said pin head, said pin shaft having a shaft portion lying in said insulating bushes and a shaft end protruding from said separating plate on an upper side of said separating plate, with a contact surface.

13. The electrical machine according to claim 12, wherein said connection pins are inserted in said insulating bushes, which are disposed in said separating plate in a coded manner, in such a coded manner that said contact surface of said insulating bushes, protruding from said separating plate and aligned with a longitudinal side of said separating plate, are in line with one another.

14. The electrical machine according to claim 1, wherein to stabilize said connection pins against tilting, said connection pins have on a shaft side at least one circumferential groove formed therein, and a sealing ring disposed in said circumferential groove.

15. The electrical machine according to claim 1, wherein to secure an axial position of said connection pins with respect to said insulating bushes, said connection pins have on a shaft side a circumferential groove formed therein for an outer securing ring.

16. The electrical machine according to claim 1, wherein said connection pins have an end face with a threaded bore extending in a longitudinal direction of said connection pin, for a fixing screw for a screw-contacting of a respective one of said connecting lines.

17. The electrical machine according to claim 1, wherein said connecting lines are screw-contacted with respect to said connection pins while running substantially at right angles thereto.

18. The electrical machine according to claim 1, wherein:
said separating plate is formed from metal;
said insulating bushes are formed from an electrically non-conducting material; and
said connection pins are formed from an electrically conducting material.

19. The electrical machine according to claim 1, further comprising a mounting platform disposed on an outer side of said machine housing, in a substantially tangentially aligned manner for mounting power electronics including converters, said mounting platform having a number of contact connections for electrical contacting, including screw-contacting, with said connection pins.

20. The electrical machine according to claim 19, wherein said mounting platform has a housing, covering said mounting platform in a manner of a hood, for receiving the power electronics.

21. The electrical machine according to claim 19, further comprising fluid channels for a cooling medium, including oil, disposed outside said line channel and are in connection with an interior housing space, and open out into said mounting platform.

22. The electrical machine according to claim 1, wherein the electrical machine is a generator.

23. The electrical machine according to claim 3, wherein said first coding element is an axial groove and said second coding element is a coding pin.

24. The electrical machine according to claim 4, wherein to stabilize said insulating bushes against tilting, said insulating bushes have on a shaft side two axially spaced-apart circumferential grooves formed therein and a sealing ring disposed in each of said two axially spaced-apart circumferential grooves.

25. The electrical machine according to claim 12, wherein said pin head is a square pin head and said contact surface is a planar contact surface.

26. The electrical machine according to claim 1, wherein to stabilize said connection pins against tilting, said connection pins have on a shaft side two axially spaced-apart circumferential grooves formed therein and a sealing ring disposed in each of said two axially spaced-apart circumferential grooves.

27. The electrical machine according to claim 1, wherein:
said separating plate is formed from aluminum;
said insulating bushes are formed from plastic; and
said connection pins are formed from brass.

28. A machine housing of an electrical machine, the machine housing comprising:
a line channel;
a separating plate;
a housing wall having a through-opening formed therein and opening out into said line channel for connecting lines disposed between coil windings and machine connections, said line channel being covered by said separating plate; and
insulating bushes with connection pins inserted in said insulating bushes in a position-coded manner as machine connections for the connecting lines, said insulated bushes fitted in said separating plate.

29. An electrical machine, including a fluid-cooled machine, for operating a power unit or working unit of a commercial vehicle, the electrical machine comprising:
coil windings;
machine connections;
connecting lines disposed between said coil windings and said machine connections; and
a machine housing, containing:
a line channel;
a separating plate;
a housing wall having a through-opening formed therein and opening out into said line channel for said connecting lines, said line channel being covered by said separating plate; and
insulating bushes with connection pins inserted in said insulating bushes in a position-coded manner as machine connections for said connecting lines, said insulated bushes fitted in said separating plate.
